(19) United States
(12) Patent Application Publication
(10) Pub. No.: US 2012/0087149 A1
(43) Pub. Date: Apr. 12, 2012

(54) ULTRA-THIN LIGHT GUIDE FOR CLUSTER GAUGE ILLUMINATION OVER DISPLAY STRUCTURES

(75) Inventors: Paul Fredrick Luther Weindorf, Novi, MI (US); Jon Phillip Bay, Saline, MI (US); Matthew Timothy Gaynier, Royal Oak, MI (US); Elizabeth Wickey, Royal Oak, MI (US)

(73) Assignee: VISTEON GLOBAL TECHNOLOGIES, INC., Van Buren Twp., MI (US)

(21) Appl. No.: 12/900,817

(22) Filed: Oct. 8, 2010

(51) Int. Cl. F21V 8/00

(52) U.S. Cl. 362/612; 362/617

(57) ABSTRACT

An ultra-thin light guide assembly includes a light guide having a maximum thickness of one millimeter, a light source disposed adjacent a portion of the light guide to emit light rays into the light guide, a reflective material disposed on at least a portion of a first side of the light guide to maximize an internal reflection of the light rays in the light guide, a light extraction feature integrated with the light guide to direct light rays through a second side of the light guide, and a flexible circuit disposed adjacent at least a portion of the light guide, the light source in electrical communication with the flexible circuit to selective energize the light source.

### FIELD OF THE INVENTION

The present invention relates generally to a display gauge for a vehicle. In particular, the invention is directed to an ultra-thin light guide assembly and a display system including the ultra-thin light guide assembly.

### BACKGROUND OF THE INVENTION

Providing automotive instrument cluster gauge and ring illumination by conventional methods is limited by the space available in a backplate region for lighting features. In order to alleviate this problem, displays have traditionally been cut to shape around the gauge borders. Conventional solutions lead to increased cost and lighting problems in applications including a display (e.g. liquid crystal).

Another method of illumination includes raising a graphic plane of the gauge graphics to allow for clearance of a traditional light guide for gauge illumination. However, the raised graphic plane of the gauge would be visually distinguishable from a graphics plane across a front surface of an associated display.

It would be desirable to develop an ultra-thin light guide assembly and a display system including the ultra-thin light guide assembly, wherein the ultra-thin light guide assembly provides suitable illumination of at least one component while maintaining an ultra-low profile.

### SUMMARY OF THE INVENTION

Concordant and consistent with the present invention, an ultra-thin light guide assembly and a display system including the ultra-thin light guide assembly, wherein the ultra-thin light guide assembly provides suitable illumination of at least one component while maintaining an ultra-low profile, has surprisingly been discovered.

In one embodiment, an ultra-thin light guide assembly comprises: a light guide having a maximum thickness of one millimeter; a light source disposed adjacent a portion of the light guide to emit light rays into the light guide; a reflective material disposed on at least a portion of a first side of the light guide to maximize an internal reflection of the light rays in the light guide; a light extraction feature integrated with the light guide to direct light rays through a second side of the light guide; and a flexible circuit disposed adjacent at least a portion of the light guide, the light source in electrical communication with the flexible circuit to selective energize the light source.

In another embodiment, a display system comprising: a frame having a plurality of apertures formed therein; a ultra-thin light guide assembly disposed adjacent the frame, the light guide assembly including: a light guide having a first side and a second side opposite the first side; a light source disposed adjacent a portion of the light guide to emit light rays into the light guide; a reflective material disposed on at least a portion of a first side of the light guide to maximize an internal reflection of the light rays in the light guide; a light extraction feature integrated with the light guide to direct light rays through a second side of the light guide; and a flexible circuit disposed adjacent at least a portion of the light guide, the light source in electrical communication with the flexible circuit to selective energize the light source; and a display disposed adjacent the frame, wherein at least a portion of the display is viewable through an aperture formed in the frame.

In yet another embodiment, a display system comprises: a frame having a plurality of apertures formed therein; a ultra-thin light guide assembly disposed adjacent the frame, the light guide assembly including: a light guide having a first side and a second side opposite the first side; a light source disposed adjacent a portion of the light guide to emit light rays into the light guide; a reflective material disposed on at least a portion of a first side of the light guide to maximize an internal reflection of the light rays in the light guide; a light extraction feature integrated with the light guide to direct light rays through a second side of the light guide; and a flexible circuit disposed adjacent at least a portion of the light guide, the light source in electrical communication with the flexible circuit to selective energize the light source; an appliqué disposed adjacent the second side of the light guide to receive at least a portion of the light rays exiting the second side of the light guide; and a display disposed adjacent the frame, wherein at least a portion of the display is viewable through an aperture formed in the frame and a portion of the light guide overlays a portion of the display.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a front elevational view of a display system according to an embodiment of the present invention;

FIG. 2 is a partially exploded front perspective view of the display system of FIG. 1;

FIG. 3 is a rear perspective view of the display system of FIG. 1; and

FIG. 4 is an enlarged fragmentary cross-sectional view of the display system of FIG. 1 taken along line 4-4.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner.

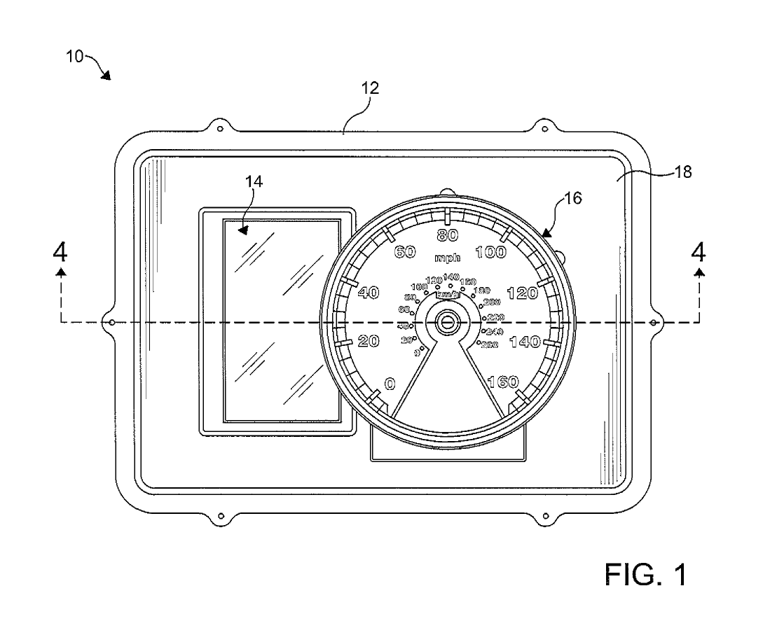

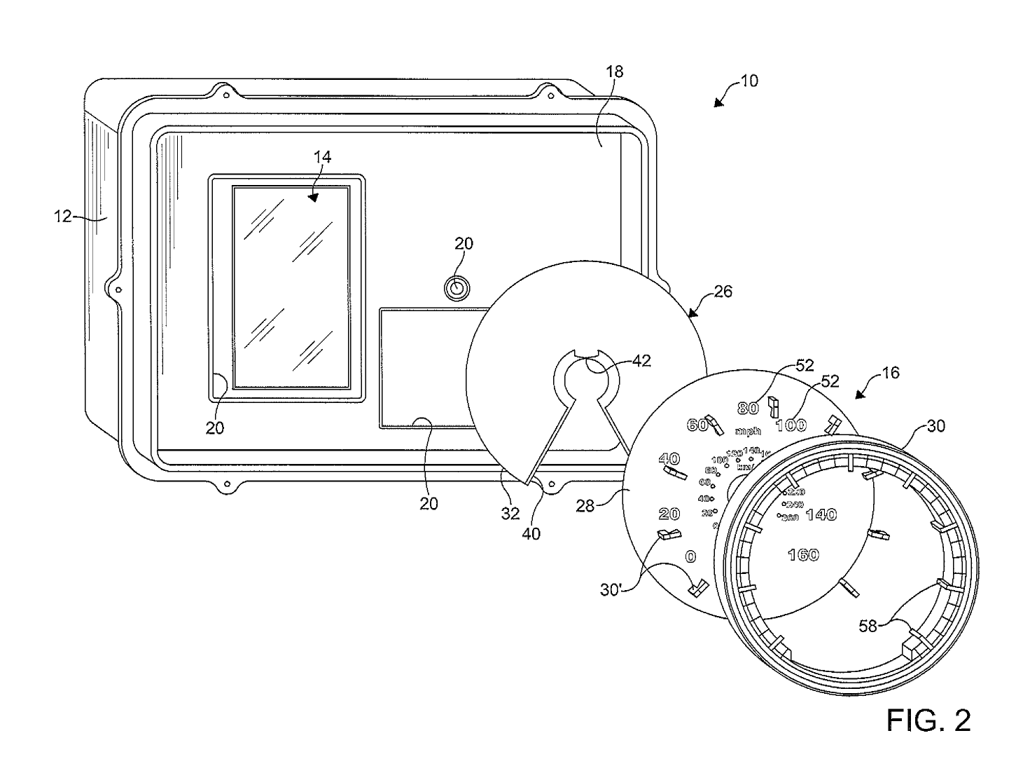

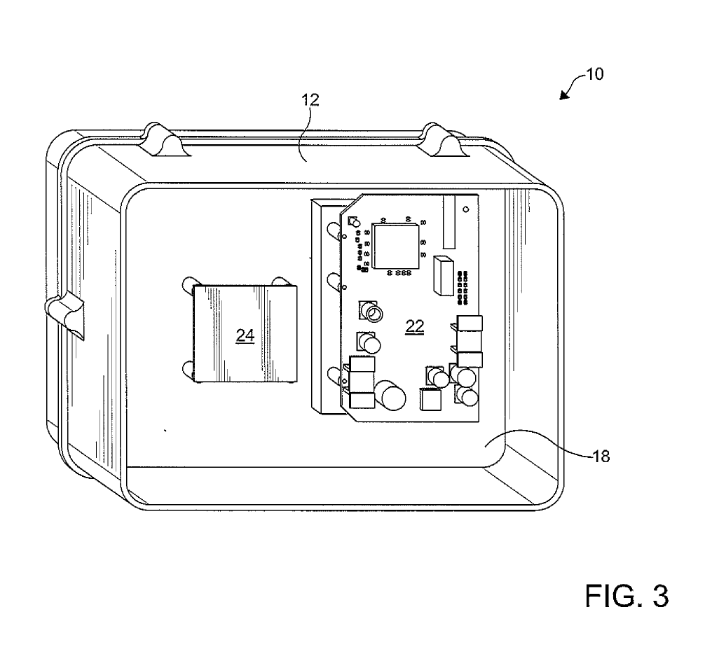

FIGS. 1-4 illustrate a display system 10 according to an embodiment of the present invention. As shown, the system 10 includes a housing 12, a display 14 secured to the housing 12, and a gauge 16 secured to the housing 12. As a non-limiting example, at least a portion of the gauge 16 overlays a portion of the display 14. It is understood that the housing 12 may be a relatively static portion of an instrument panel disposed in a vehicle. However, any housing 12 or means for securing a relative position of the display 14 and the gauge 16 can be used. It is further understood that the display a 14 and the gauge 16 can have any position relative to one another.

The display 14 is typically a liquid crystal display (LCD) for presenting a visual output to a user to convey information about a vehicle information or status of a vehicle system (e.g. navigation, speed, odometer, telltales, and the like). However, it is understood that any type of display, now known or later developed, can be used to present the visual output such as a thin-film transistor (tft) display, for example.

In the embodiment shown, the display 14 is secured to the housing 12 by a frame 18 having a plurality of apertures 20 formed therein, wherein at least one of the apertures 20 is configured to pass the visual output of the display 14 therethrough. A circuit board 22 (e.g. a rigid printed circuit board) is disposed adjacent the frame 18 and in electrical communication with the display 14 to energize the display 14 and to control the generation of the visual output. It is understood that the circuit board 22 can be in electrical communication with other vehicle components and systems including a component of the gauge 16. It is understood that the circuit board 22 can include any number of electrical components to selectively energize the display 14 and control the visual output presented by the display 14. It is further understood that the circuit board 22 can be positioned in any location relative to the display 14.

The gauge 16 is secured to the housing 12 by the frame 18. In the embodiment shown, the gauge 16 includes a main circuit board 24 mounted to the frame 18, an ultra-thin light guide assembly 26 disposed adjacent the frame 18, an appliqué 28 disposed adjacent the light guide assembly 26, and a decorative component 30 disposed adjacent the appliqué 28.

The main circuit board 24 is typically a rigid printed circuit board disposed adjacent the gauge 16 to provide electrical energy to the components of the gauge 16 (e.g. light sources, motors, etc.) to selectively energize the components. It is understood that the circuit board 22 and the main circuit board 24 can be formed integrally as a single circuit board. However, design space may dictate that separate circuit boards 22, 24 be used. It is understood that the main circuit board 24 can include any number of electrical components to selectively energize the gauge 16 and control the components (e.g. pointer) associated with the gauge 16. It is further understood that the main circuit board 24 can be positioned in any location relative to the gauge 16.

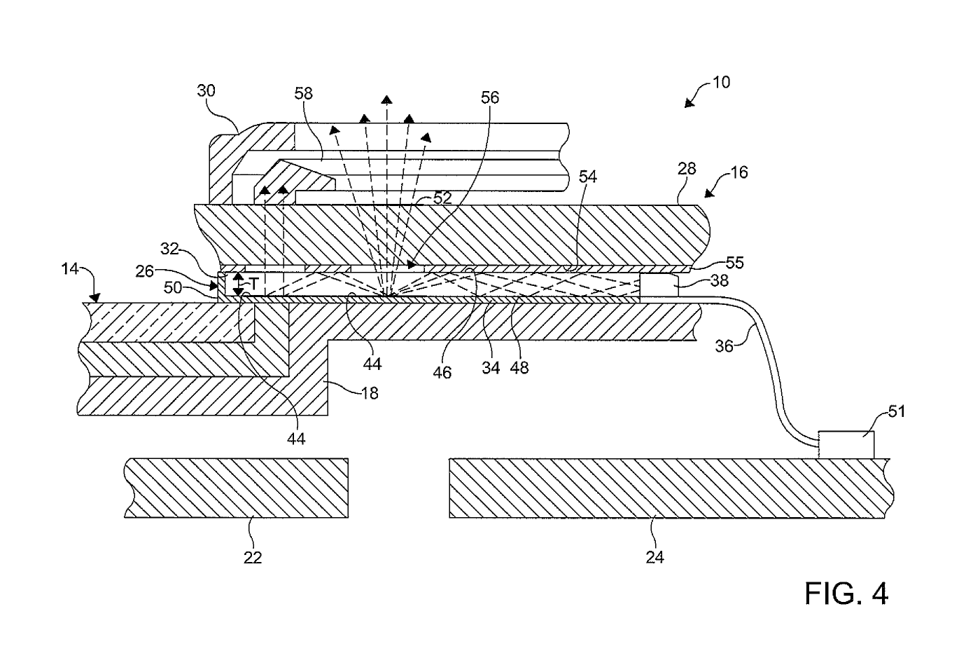

The light guide assembly 26 is disposed adjacent the frame 18. As more clearly shown in FIG. 4, the light guide assembly 26 includes an ultra-thin light guide 32 having a reflective element 34 disposed thereon, a flexible circuit 36 disposed adjacent the ultra-thin light guide 32, and a light source 38 coupled to the flexible circuit 36 and disposed adjacent the ultra-thin light guide 32 to emit light into the ultra-thin light guide 32. It is understood that the light guide assembly 26 can include additional components.

The ultra-thin light guide 32 can be formed from any material that can pass light therethrough. As a non-limiting example, the ultra-thin light guide 32 is formed from a polymer or plastic such as Poly(methyl methacrylate) (PMMA), polycarbonate (PC), polystyrene (PS), or other material now known or later developed. The ultra-thin light guide 32 is typically planar and has a thickness T that is less than 1 mm. In certain embodiments, the thickness T of the ultra-thin light guide 32 is less than 0.6 mm. As shown, the ultra-thin light guide 32 has a substantially planar disc shape with a cut-out section 40 and an aperture 42 for receiving a pointer (not shown) therethrough. However, it is understood that the ultra-thin light guide 32 can have any shape and size. In certain embodiments, the ultra-thin light guide 32 includes light extraction features 44 disposed therein or thereon. As a non-limiting example, the light extraction features 44 can include a ridge or tooth formed in the ultra-thin light guide 32 to direct light rays through a front surface 46 of the ultra-thin light guide 32. As a further non-limiting example, the light extraction features 44 include a reflective paint for directing light rays through the front surface 46 of the ultra-thin light guide 32. It is understood that the light extraction features 44 can include any means for re-directing light rays to exit the ultra-thin light guide 32.

The reflective element 34 is typically disposed on at least a portion of a rear surface 48 of the ultra-thin light guide 32 opposite the front surface 46 to maximize an internal reflection of the light rays in the ultra-thin light guide 32. As a non-limiting example, the reflective element 34 can be a reflective paint applied to the rear surface 48. It is understood that the reflective element 34 can be integrated with the ultra-thin light guide 32. It is further understood that any reflective material or structure can be used to maximize the internal reflection of light rays in the ultra-thin light guide 32.

In certain embodiments, the reflective element 34 is disposed adjacent an edge 50 of the ultra-thin light guide 32 opposite the light source 38 to block light rays from exiting the ultra-thin light guide 32 through the edge 50.

The flexible circuit 36 is disposed adjacent at least a portion of the ultra-thin light guide 32. As shown, at least a portion of the flexible circuit 36 is coupled (e.g. with adhesive or other coupling means) to a portion of the ultra-thin light guide 32 adjacent the aperture 42. It is understood that the flexible circuit 36 can be disposed in any position relative to the ultra-thin light guide 32. It is further understood that the flexible circuit 36 can be in electrical communication with the main circuit board 24 with a flex connector 51 known in the art.

The light source 38 is typically a side-emitting light emitting diode (LED) having a height substantially similar to the ultra-thin light guide 32. However, it is understood that any light source, now known or later developed, having any dimensions can be used. As shown, the light source 38 is mounted to the flexible circuit 36 and in electrical communication therewith, wherein the flexible circuit 36 facilitates the selective energizing of the light source 38 to selectively illuminate the ultra-thin light guide 32.

The appliqué 28 is disposed adjacent the front surface 46 of the ultra-thin light guide 32. As shown, the appliqué 28 includes a plurality of graphic indicia 52 (e.g. numbers, telltales, etc.). As a non-limiting example, at least a portion of a rear surface 54 of the appliqué 28 disposed adjacent the ultra-thin light guide 32 is a reflective surface to reflect light rays passing through the ultra-thin light guide 32. In certain embodiments, a reflective element 55 is disposed on the rear surface 54 of the appliqué 28. As a further non-limiting example, portions of the rear surface 54 of the appliqué 28 are non-reflective to allow light rays to exit the ultra-thin light guide 32 and to pass through a portion of the appliqué 28 (e.g. illuminating the graphic indicia 52). In certain embodiments, color passes 56 are formed in at least one of the appliqué 28 and the reflective element 55 to pass light therethrough.

The decorative component 30 is typically a three-dimensional component (e.g. mask, decorative ring, and the like) disposed adjacent the appliqué 28 to provide an aesthetic contour to the gauge 16. As a non-limiting example, the decorative component 30 can include illumination features 58 such as cut-outs and optical elements that allow light to pass through (or by) a portion of the decorative component 30. In certain embodiments, a plurality of prismatic chaplets 30′ are disposed adjacent the appliqué 28, wherein the prismatic chaplets 30′ are decorative components that receive light rays from the ultra-thin light guide 32 and direct the light in a pre-defined lighting pattern.

In use, the light source 38 is selectively energized and emits light rays into the ultra-thin light guide 32 (e.g. along a peripheral edge of the ultra-thin light guide 32). The light rays illuminate at least a portion of the ultra-thin light guide 32 in a manner similar to the principle of total internal reflection. The light extraction feature 44 directs a portion of the light rays through the front surface 46 of the ultra-thin light guide 32 to illuminate a component (e.g. the appliqué 28, the decorative element 30, the prismatic chaplets 30′) disposed adjacent the front surface of the ultra-thin light guide 32. As a non-limiting example, the light rays exiting the ultra-thin light guide 32 illuminate the graphic indicia 52 of the appliqué 28. In certain embodiments, the ultra-thin light guide 32 extends over at least a portion of the display 14 to provide a unique configuration of the display system 10. It is understood that the ultra thin light guide 32 allows lighted structures to be placed directly over display areas and borders, while still maintaining a graphic appearance that is flush with the display surface.

The present invention provides the ultra thin light guide 32 with a maximum thickness T of one millimeter. The ultra thin light guide 32 can be positioned between the display 14 and the appliqué 28 (or other gauge graphics) to provide illumination to the appliqué 28. Since the thickness T of the ultra thin light guide 32 is relatively small, the illuminated graphic indicia 52 on the appliqué 28 appear to a user as being located on the same plane as a front surface of the display 14. Accordingly, the ultra thin light guide 32 maximizes a number of layout options for the display system 10, while providing a unique means of illumination.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. An ultra-thin light guide assembly comprising:
a light guide having a maximum thickness of one millimeter;
a light source disposed adjacent a portion of the light guide to emit light rays into the light guide;
a reflective material disposed on at least a portion of a first side of the light guide to maximize an internal reflection of the light rays in the light guide;
a light extraction feature integrated with the light guide to direct light rays through a second side of the light guide; and
a flexible circuit disposed adjacent at least a portion of the light guide, the light source in electrical communication with the flexible circuit to selective energize the light source.

2. The light guide assembly according to claim 1, wherein the light guide has a maximum thickness of 0.6 millimeters.

3. The light guide assembly according to claim 1, wherein the light source is a side-emitting light emitting diode.

4. The light guide assembly according to claim 1, wherein the light source has a maximum thickness of one millimeter.

5. The light guide assembly according to claim 1, wherein the light source is disposed adjacent a first end of the light guide and a portion of the reflective material is disposed adjacent a second end of the light guide opposite the first end.

6. A display system comprising:
a frame having a plurality of apertures formed therein;
an ultra-thin light guide assembly disposed adjacent the frame, the light guide assembly further comprising:
a light guide having a first side and a second side opposite the first side;
a light source disposed adjacent a portion of the light guide to emit light rays into the light guide;
a reflective material disposed on at least a portion of a first side of the light guide to maximize an internal reflection of the light rays in the light guide;
a light extraction feature integrated with the light guide to direct light rays through a second side of the light guide; and
a flexible circuit disposed adjacent at least a portion of the light guide, the light source in electrical communication with the flexible circuit to selective energize the light source; and
a display disposed adjacent the frame, wherein at least a portion of the display is viewable through an aperture formed in the frame.

7. The display system according to claim 6, wherein at least a portion of the light guide overlays a portion of the display.

8. The display system according to claim 6, wherein the light guide has a maximum thickness of one millimeter.

9. The display system according to claim 8, wherein the light guide has a maximum thickness of 0.6 millimeters.

10. The display system according to claim 6, wherein the light source is a side-emitting light emitting diode.

11. The display system according to claim 6, wherein the light source has a maximum thickness of one millimeter.

12. The display system according to claim 6, wherein light source is disposed adjacent a first end of the light guide and a portion of the reflective material is disposed adjacent a second end of the light guide opposite the first end.

13. A display system comprising:
a frame having a plurality of apertures formed therein;
an ultra-thin light guide assembly disposed adjacent the frame, the light guide assembly further comprising:
a light guide having a first side and a second side opposite the first side;
a light source disposed adjacent a portion of the light guide to emit light rays into the light guide;
a reflective material disposed on at least a portion of a first side of the light guide to maximize an internal reflection of the light rays in the light guide;
a light extraction feature integrated with the light guide to direct light rays through a second side of the light guide; and
a flexible circuit disposed adjacent at least a portion of the light guide, the light source in electrical communication with the flexible circuit to selective energize the light source;
an appliqué disposed adjacent the second side of the light guide to receive at least a portion of the light rays exiting the second side of the light guide; and
a display disposed adjacent the frame, wherein at least a portion of the display is viewable through an aperture formed in the frame and a portion of the light guide overlays a portion of the display.

14. The display system according to claim 13, wherein the light guide has a maximum thickness of one millimeter.

15. The display system according to claim 13, wherein the light guide has a maximum thickness of 0.6 millimeters.

16. The display system according to claim 13, wherein the light source is a side-emitting light emitting diode.

17. The display system according to claim 13, wherein the light source has a maximum thickness of one millimeter.

18. The display system according to claim 13, wherein light source is disposed adjacent a first end of the light guide and a portion of the reflective material is disposed adjacent a second end of the light guide opposite the first end.

19. The display system according to claim 13, wherein the appliqué include a first surface that abuts the light guide and at least a portion of the first surface of the appliqué is reflective to maximize an internal reflection of the light rays in the light guide.

20. The display system according to claim 13, further comprising a decorative component disposed adjacent a surface of the appliqué opposite the light guide assembly.
